(19) United States
(12) Patent Application Publication
(10) Pub. No.: US 2022/0352839 A1
(43) Pub. Date: Nov. 3, 2022

(54) A MOTOR DRIVE SIGNAL GENERATOR

(71) Applicant: ANIMAL DYNAMICS LIMITED, Oxford (GB)

(72) Inventor: Ernesto Artaza, Oxford (GB)

(73) Assignee: ANIMAL DYNAMICS LIMITED, Oxford (GB)

(21) Appl. No.: 17/616,667

(22) PCT Filed: Jun. 5, 2020
(86) PCT No.: PCT/GB2020/051364

§ 371 Date: Dec. 5, 2021

(30) Foreign Application Priority Data
Jun. 5, 2019 (GB) 1908004.3

(51) Int. Cl. H02P 27/02

(52) U.S. Cl. CPC H02P 27/02; H02P 2209/11; H02P 2209/07

(57) ABSTRACT

A motor drive signal generator configured to combine at least a part of a first input waveform with at least a part of a second input waveform to create a compound waveform, wherein the first waveform is a sine wave and the second input waveform is a square wave.

### DESCRIPTION OF INVENTION

The present invention relates to a motor drive signal generator and a motor control system. More particularly, the invention relates to a motor drive signal generator to drive a motor in a flapping wing arrangement of an unmanned aerial vehicle (UAV). The motor drive signal generator may nevertheless drive a motor of other vehicles, such as watercraft (submersible or surface craft).

The most popular method of providing lift to a UAV is to use a plurality of propellers (e.g. 4 or more). The propellers may each be driven by a motor, which are powered by an onboard battery and individually controllable to control the flight of the UAV. Propellers can be noisy and such UAVs may have undesirable battery life. Moreover, such UAVS may be not be stable in high winds.

An alternative form of lift uses a set of flapping wings, akin to a dragon fly or a bird. A known UAV incorporating a flapping wing assembly is known from US2013/0320133. Each of the four or more wings may be driven by a single drive motor which enables the drive motor to flap the four or more wings at variable frequency based on the speed of the associated drive motor. The rotary motion of the motor may be translated into an oscillating motion of the wing by use of a mechanical connection. Alternatively, a motor drive signal may be applied directly to the motor which causes it to oscillate rather than continuously rotate. The motor shaft may oscillate within an envelope of 90°, or higher or lower than 90°

The flapping amplitude of each of the wings can be individually controlled and varied to allow for vehicle control. In addition, the wing assemblies themselves can be rotated to allow for yaw control.

US2013/0320133 describes one way of driving the motor in an oscillating manner, by providing a motor drive signal comprising a sine wave.

An object of the present invention is to provide an improved motor drive signal generator.

Accordingly, the present invention provides a motor drive signal generator configured to combine at least a part of a first input waveform with at least a part of a second input waveform to create a compound waveform.

In at least one embodiment, the shape of the first input waveform is different to the shape of the second input waveform.

In at least one embodiment, the first waveform is a sine wave.

In at least one embodiment, the sine wave is symmetrical.

In at least one embodiment, the sine wave is asymmetrical.

In at least one embodiment, the second input waveform is a square wave.

In at least one embodiment, the period of the first input waveform is substantially the same as the period of the second input waveform.

In at least one embodiment, the first input waveform and second input waveform are substantially in phase with one another.

In at least one embodiment, the maximum amplitude of the first input waveform is substantially the same as the maximum amplitude of the second input waveform.

In at least one embodiment, the maximum amplitude of the compound waveform is substantially the same as the maximum amplitude of both the first and second input waveforms.

In at least one embodiment, the motor drive signal generator is configured to combine X % of the amplitude of the first input waveform with Y % of the amplitude of the second input waveform, wherein X+Y substantially equals 100.

In at least one embodiment, X may be between 65 and 85 and Y may be between 15 and 35, wherein X+Y=100.

In at least one embodiment, X may be between 40 and 60 and Y may be between 40 and 60, wherein X+Y=100. In one embodiment X is not the same as Y.

In at least one embodiment, X may be between 15 and 35 and Y may be between 65 and 85, wherein X+Y=100.

In at least one embodiment, X is 75 and Y is 25.

In at least one embodiment, X is 50 and Y is 50.

In at least one embodiment, X is 25 and Y is 75.

In at least one embodiment, X is between 65 and 75, and Y is between 25 and 35.

In at least one embodiment, X is 69 and Y is 31.

The invention also provides a motor drive signal generator comprising a wave combining module to combine at least a part of a first input waveform with at least a part of a second input waveform to create a compound waveform.

In at least one embodiment, at least one signal conditioning module configured to reduce the amplitude of the first and/or second input waveform by a predetermined amount, and pass said conditioned first and/or second input waveforms to said wave combining module.

The invention also provides a motor control system comprising:
a first waveform generator configured to generate a first waveform;
a second waveform generator configured to generate a second waveform;
a motor drive signal generator according to any preceding claim, comprising a wave combining module, configured to receive and combine first and second waveforms; and
a motor arranged to be driven by the compound waveform.

In at least one embodiment, the motor control system further comprises:
a first signal conditioning module arranged to receive and condition the first waveform, and send said conditioned first waveform to the motor drive signal generator; and
a second signal conditioning module arranged to receive and condition the second waveform and send said conditioned second waveform to the motor drive signal generator

In at least one embodiment, the motor control system further comprises a control module configured to control the first waveform generator, second waveform generator, first signal conditioning module, second signal conditioning module and wave combining module.

In at least one embodiment, the motor control system further comprises at least one wing operatively connected to and driven by the motor.

The invention also provides an unmanned aerial vehicle comprising a motor control system according to the invention.

Embodiments of the present invention will now be described by way of non-limiting examples, with reference to the figures, in which:

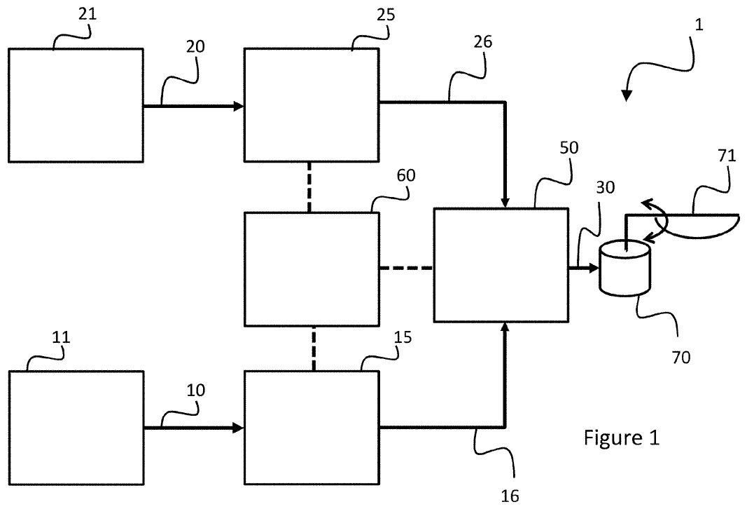

FIG. 1 schematically illustrates a motor drive signal generator embodying the present invention;

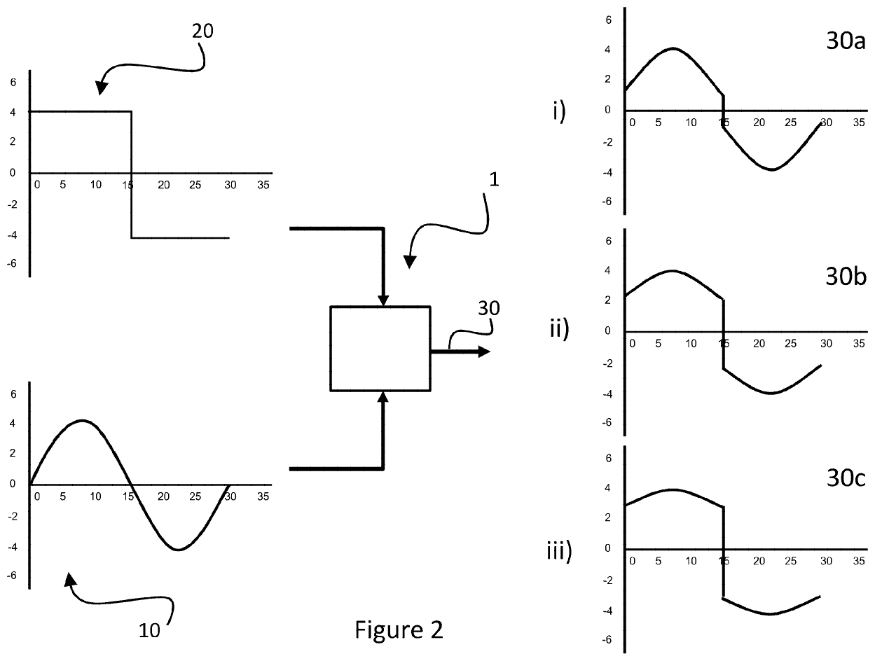

FIG. 2 schematically illustrates the motor drive signal generator in use; and

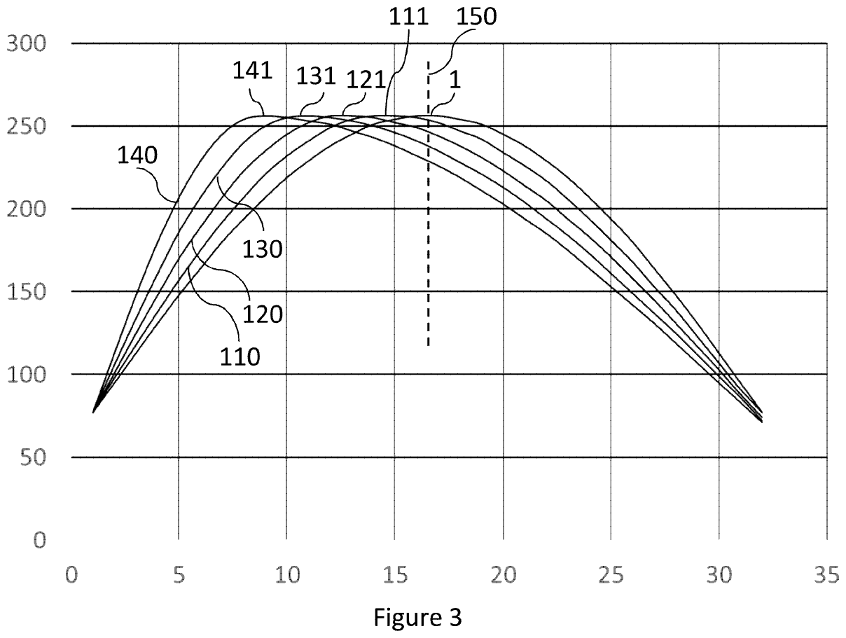

FIG. 3 illustrates some example asymmetrical sine waves.

FIGS. 1 and 2 illustrate a motor drive signal generator 1 configured to combine at least a part of a first input waveform 10 with at least a part of a second input waveform 20 to create a compound waveform 30.

In one or more embodiments, the shape of the first input waveform 10 is different to the shape of the second input waveform 20. A non-exhaustive list of such waveform shapes comprises sine, square, ramp, sawtooth, triangular etc.

In at least one embodiment, the first wave form 10 is a sine wave, as illustrated in FIG. 2. Preferably, as also illustrated in FIG. 2, the sine wave forming the first waveform 10 is symmetrical. By symmetrical is meant that the peak of the sine wave is located substantially in the middle of the half cycle of the sine wave. In another embodiment, as shown in FIG. 3, the sine wave forming the first input waveform 10 may be asymmetrical. FIG. 3 only illustrates one peak of a half cycle of the sine wave. Various illustrative asymmetrical sine waves 110, 120, 130, 140 are shown. The peak (point of maximum amplitude) 111, 121, 131, 141 is clearly shown in FIG. 3 as being offset from the centre point 150 of the half cycle of the sine wave. Consequently, the sine waves 110, 120, 130, 140 are asymmetrical.

In at least one embodiment, the second input waveform 20 is a square wave, as illustrated in FIG. 2.

In at least one embodiment, the period of the first input waveform 10 is substantially the same as the period of the second input waveform 20. This is illustrated in FIG. 2. In at least one embodiment, the first input waveform 10 and second input waveform 20 are substantially in phase with one another. Preferably, the periods are identical and they are in phase with one another.

In at least one embodiment, the maximum amplitude of the first input waveform 10 is substantially the same as the maximum amplitude of the second input waveform 20. In FIG. 2, the maximum amplitude of each of the first 10 and second 20 input wave forms is shown with a value of 4. The units of measurement are not of relevance.

The present invention provides a motor drive signal generator which combines the first input waveform 10 and second input waveform 20 together to create a compound waveform 30. In at least one embodiment, this is performed by a wave combining module 50 which receives at least a part of the first input waveform 10 and at least a part of the second input waveform 20 and creates a compound waveform 30.

In at least one embodiment, the maximum amplitude of the compound waveform 30 is substantially the same as the maximum amplitude of both the first 10 and second 20 input waveforms.

FIG. 2 illustrates three example compound waveforms 30a, 30b, 30c. The differences between those will be discussed below. Nevertheless, it will be noted that the maximum amplitude of each of the example compound waveforms 30a, 30b, 30c is 4, which is the same as the maximum amplitude of each of the first 10 and second 20 input waveforms.

In at least one embodiment, the motor drive signal generator 1 is configured to combine X % of the amplitude of the first input waveform 10 with Y % of the amplitude of the second input waveform 20, wherein X+Y substantially equals 100. Consequently, when the maximum amplitude of each of the first 10 and second 20 input waveforms is the same, the maximum amplitude of the compound waveform 30a, 30b, 30c has the same amplitude.

In at least one embodiment, X may be equal to 75 and Y may be equal to 25. This is illustrated in the compound waveform 30a shown in FIG. 2. In other words, the compound waveform 30a is comprised of 75% of the amplitude of the first input (sine) waveform 10 and 25% of the second input (square) waveform 20. Consequently, because the compound waveform 30a comprises more of the sine wave 10 than it does the square wave 20, it will be noted that the overall shape of the compound waveform 30a is predominantly still reminiscent of a sine wave.

In at least one embodiment, as illustrated by compound waveform 30b shown in FIG. 2, both X and Y may be equal to 50. That is to say that the compound waveform 30b is comprised of 50% of the amplitude of the first input (sine) waveform 10 and 50% of the second input (square) waveform 20.

In the third example, illustrated by compound waveform 30c shown in FIG. 2, X is 25 and Y is 75. Accordingly, the compound waveform 30c is comprised of only 25% of the amplitude of the first input (sine) waveform 10 and 75% of the second input (square) waveform 20. Consequently, the compound waveform 30c is more reminiscent of a square wave, with its sharp change in amplitude at the point of transition between the half cycles; but nevertheless with a slight oscillation over the cycle, caused by the portion of the first input (sine) waveform 10 within the compound waveform 30c.

In one embodiment, X may be between the values of 65% and 75% and Y may be between the values of 25% and 35%. In one embodiment, X may be 69 and Y may be 31. That is to say that the compound waveform is comprised of 69% of the first input (sine) waveform and 31% of the second input (square) waveform 20.

In one embodiment, X may be between 65 and 85 and Y may be between 15 and 35, wherein X+Y=100.

In one embodiment, X may be between 40 and 60 and Y may be between 40 and 60, wherein X+Y=100. In one embodiment X is not the same as Y.

In one embodiment, X may be between 15 and 35 and Y may be between 65 and 85, wherein X+Y=100.

The motor drive signal generator 1 may receive the first input waveform 10 and the second input waveform 20 from an external source (e.g. a waveform generator). In one embodiment, the motor drive signal generator 1 itself may comprise a first waveform generator 11 and a second waveform generator 21, as shown in FIG. 1. The first waveform generator 11 is configured to generate a first waveform 10. The second waveform generator 21 is configured to generate a second waveform 20.

As noted above, the motor drive signal generator 1 is then configured to combine at least a part of the first input waveform 10 with at least a part of the second input waveform 20 to create the compound waveform 30.

In one embodiment, the motor drive signal generator 1 further comprises a first signal conditioning module 15 arranged to receive and condition the first input waveform 10. The motor control system 1 may further comprise a second signal conditioning module 25 arranged to receive and condition the second input waveform 20. Furthermore, the motor drive signal generator 1 may comprise a wave combining module 50, configured to receive and combine the conditioned first waveform 16 and the conditioned second waveform 26. In such an embodiment, the wave combining module 50 may simply combine the signals sent to it. In another embodiment, rather than requiring a discrete wave combining module 50 and first and second signal conditioning modules 15, 25, a single arrangement may be provided which is configured to both condition and combine first and second input waveforms. By “condition” is meant to reduce the amplitude of the incoming signal by a predetermined extent.

The motor drive signal generator may further comprise a controller 60, which is operable to control the first signal conditioning unit 15, second signal conditioning unit 25 and/or the wave combining module 50. The controller 60 may adjust the extent and/or nature of the conditioning applied by the first signal conditioning unit 15 and second signal conditioning unit 25. The controller 60 may control the extent and/or nature of the combining of the waveforms 10, 20.

In the figures, the components of embodiments of the present invention have been described as discrete modules. This may be the case, but is not essential. The motor drive signal generator may be embodied partially or entirely within a single unit. In at least one embodiment, the motor drive signal generator may be embodied in software on a computer.

The present invention further provides a method of generating a motor drive signal, comprising:
receiving a first input waveform;
receiving a second input waveform
combining at least a part of a first input waveform with at least a part of a second input waveform to create a compound waveform

The applicant has recognised that driving a motor 70 of a flapping wing assembly with a motor drive signal comprising only a sine wave may be inefficient. By combining first and second waveforms, e.g. sine wave and a square wave, according to embodiments of the invention, a compound waveform is generated which, when applied to the motor as a motor drive signal, is more energy efficient compared to known arrangements.

In the context of a flapping wing device, a sine wave waveform mimics the motion of the wing/spring combination. It can be considered to be forced harmonic motion. When operated at resonance, this becomes simple harmonic motion. However, in a real scenario, aerodynamic loads from the wing and striction (stop start friction) or friction from the mechanical mechanism prevents this motion from being purely sinusoidal.

Driving the wing with a square wave signal gives maximum power but a lot of power is wasted. A pure sine wave enables power to be saved but cannot produce the lift required. A combination of the two waveforms enables power wastage to be reduced whilst ensuring that enough lift generation is maintained through applying maximum power to the motor.

In a compound waveform combining both a sine wave and a square wave, the sine wave drives the wing during the stroke of the wing 71 but the inclusion of the square wave allows little or no work to be done at the end of the stroke when the wing 71 is changing direction (i.e. velocity drops to zero) and does not need driving. Such a compound drive signal is more efficient than one comprising just a sine wave or just a square wave.

An energy recovery arrangement (e.g. a spring or springs) may be associated with the flapping wing unit, to recover some of the energy at the extent of the oscillation of the wing. Such an energy recovery system can exhibit asymmetric properties, whereby the spring rate in one direction (i.e. clockwise winding up) can be different to the other direction (i.e. anti-clockwise unwinding). This asymmetry in the spring can cause an asymmetry in the flapping of the wing 71. However, this can be corrected within the waveform by introducing an asymmetric aspect to the sine part of the waveform, as shown in FIG. 3. Driving the spring more in the lower spring rate direction and less in the higher spring rate direction generates symmetric flapping and optimises the system. The spring asymmetry can be corrected for with the waveform asymmetry. In FIG. 3, the asymmetry is demonstrated by skewing the peak of the sine wave to the left. This is not essential. The peak may alternatively be skewed to the right.

When used to generate lift for a UAV, there may also be asymmetric loading on the wing 71 when it is flapping. The loading may be transferred to any spring arrangement. Consequently, the asymmetry of the sine waveform can be configured also to counter or reduce the effects of asymmetric loading on the wing 71

The sine wave may be tuned to account for the mechanical characteristics of the motor 70 and wing 71 being driven.

Embodiments of the claimed invention are configured to drive the wing 71 through its period of maximum velocity i.e. when it is mid-stroke, using the sine wave, but when the wing is at either end of the stroke, the square wave is applied to ensure that less power is applied as the wing is moving more slowly and enabling the energy recovery system (the springs) to change the wing direction.

It has been found that a compound motor drive signal which comprises around 69% of a sine wave and 31% of a square wave may, for some arrangements, minimise power consumption of the motor whilst still maintaining sufficient lift of the flapping wing assembly.

In another embodiment, the compound motor drive signal may comprise around 90% of a sine wave (first input waveform) and 10% of a square wave (second input waveform). In other words, X=90 and Y=10.

In another embodiment, the compound motor drive signal may comprise around 97% of a sine wave (first input waveform) and 3% of a square wave (second input waveform). In other words, X=97 and Y=3. It has been found that just 3% of square wave in the compound motor signal can be enough to efficiently operate the motor.

The motor drive signal generator of the present invention may be used to drive a motor, or provide an output to a controller which, in turn, drives a motor. At least one wing may be operatively connected to the motor such that an oscillation of the motor causes a corresponding oscillation (e.g. flapping) of the wing. Consequently, the wing may provide lift.

A plurality of motors, each with one or more associated wings, may be provided on an unmanned aerial vehicle (UAV) and operated so as to provide lift to, and control the flight of, the UAV. Each motor may be driven by a corresponding motor control system. In another embodiment, a plurality of motors may be driven by a corresponding motor control system.

A plurality of motors/wings is not essential. The invention comprises the provision of a single motor, single wing and associated motor control system.

Although the invention has been described herein with reference to an aerial vehicle, it nevertheless has applications in other arrangements and vehicles, such as watercraft (submersible or surface craft). For example, a watercraft may provide propulsion with a submerged flapping wing. The compound waveform of the motor drive signal generator may be supplied to the motor of such a propulsion arrangement. The wing of a motor control system embodying the invention may therefore operate in any fluid (i.e. liquid or gas), eg. water or air.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

Although certain example embodiments of the invention have been described, the scope of the appended claims is not intended to be limited solely to these embodiments. The claims are to be construed literally, purposively, and/or to encompass equivalents.

1-23. (canceled)

24. A motor drive signal generator configured to combine a part of a first input waveform with a part of a second input waveform to create a compound waveform, wherein the first waveform is a sine wave and the second input waveform is a square wave.

25. A motor drive signal generator according to claim 24, wherein the sine wave is symmetrical.

26. A motor drive signal generator according to claim 24, wherein the sine wave is asymmetrical.

27. A motor drive signal generator according to claim 24, wherein the period of the first input waveform is substantially the same as the period of the second input waveform.

28. A motor drive signal generator according to claim 24, wherein the first input waveform and second input waveform are substantially in phase with one another.

29. A motor drive signal generator according to claim 24, wherein the maximum amplitude of the first input waveform is substantially the same as the maximum amplitude of the second input waveform.

30. A motor drive signal generator according to claim 24, wherein the maximum amplitude of the compound waveform is substantially the same as the maximum amplitude of both the first and second input waveforms.

31. A motor drive signal generator according to claim 24, configured to combine X % of the amplitude of the first input waveform with Y % of the amplitude of the second input waveform, wherein X+Y substantially equals 100.

32. A motor drive signal generator according to claim 31, wherein X is between 65 and 85 and Y is between 15 and 35, wherein X+Y=100, or wherein X is between 40 and 60 and Y is between 40 and 60, wherein X+Y=100, or wherein X is between 15 and 35 and Y is between 65 and 85, wherein X+Y=100, or wherein X is between 65 and 75, and Y is between 25 and 35.

33. A motor drive signal generator according to claim 31, wherein X is 69 and Y is 31.

34. A motor drive signal generator according to claim 31, wherein X is 90 and Y is 10.

35. A motor drive signal generator according to claim 31, wherein X is 97 and Y is 3.

36. A motor drive signal generator according to claim 24, comprising a wave combining module to combine said part of the first input waveform with said part of the second input waveform to create the compound waveform.

37. A motor drive signal generator according to claim 36, further comprising at least one signal conditioning module configured to reduce the amplitude of the first and/or second input waveform by a predetermined amount, and pass said conditioned first and/or second input waveforms to said wave combining module.

38. A motor control system comprising:
a. a first waveform generator configured to generate a first waveform, wherein the first waveform is a sine wave;
b. a second waveform generator configured to generate a second waveform, wherein the second input waveform is a square wave;
c. a motor drive signal generator according to claim 37, comprising a wave combining module, configured to receive and combine first and second waveforms; and
d. a motor arranged to be driven by the compound waveform.

39. A motor control system according to claim 38, further comprising:
e. a first signal conditioning module arranged to receive and condition the first waveform, and send said conditioned first waveform to the motor drive signal generator; and
f. a second signal conditioning module arranged to receive and condition the second waveform and send said conditioned second waveform to the motor drive signal generator

40. A motor control system according to claim 39, further comprising a control module configured to control the first waveform generator, second waveform generator, first signal conditioning module, second signal conditioning module and wave combining module.

41. A motor control system according to claim 38, further comprising at least one wing operatively connected to and driven by the motor.

42. A vehicle comprising a motor control system according to claim 38.

43. An unmanned aerial vehicle comprising the vehicle of claim 19.
